(19) United States
(12) Patent Application Publication
(10) Pub. No.: US 2026/0278132 A1
(43) Pub. Date: Sep. 17, 2026

(54) BLOCKCHAIN-IMPLEMENTED DATABASE OVERLAY, VERIFICATION AND INDEXING SYSTEM

(71) Applicant: nChain Licensing AG, Zug (CH)

(72) Inventor: Craig Steven WRIGHT, London (GB)

(21) Appl. No.: 19/101,852

(22) PCT Filed: Jul. 10, 2023
(86) PCT No.: PCT/EP2023/068976

§ 371 Date: Feb. 6, 2025

(30) Foreign Application Priority Data
Aug. 9, 2022 (GB) 2211597.6

(51) Int. Cl. G06F 21/62; G06F 16/23; G06F 21/60

(52) U.S. Cl. CPC G06F 21/6218; G06F 16/2379; G06F 21/602

(57) ABSTRACT

Embodiments provide a blockchain-implemented database overlay and indexing mechanism. In one embodiment, records in the database are associated via the overlay to respective unspent outputs in transaction(s) on the blockchain. Each output comprises a locking script that specifies which keys can be used to spend the output to a further transaction. When a user wishes to access a given record in the database, the further (spending) transaction is generated and sent to the blockchain network. The further transaction comprises an unlocking script that provides the required key(s) to meet the conditions of the locking script, otherwise the blockchain's consensus mechanism will not allow spending of the output and access to the record will be denied. If, however, the requirements are met then the output is spent and the access request is deemed authorized. In this way, the consensus mechanism provides an improved permission control and user authorization solution for a database. When the output is spent by the further transaction, the overlay is updated to associate the record with the spending transaction. A transaction log may also be provided to enable swift and efficient regeneration of the database should it be required.

### FIELD

Embodiments of the disclosure provide mechanisms for improving data storage, retrieval, searching and re-indexing. In particular, a blockchain is used to implement a database overlay that maps records in the database to transactions in the ledger, thus providing a flexible but efficient indexing solution. Advantageously, the consensus mechanism, which is specified by the blockchain's protocol and implemented by the blockchain network, can be used to implement a permissioning facility, where access to the database records is only permitted upon satisfaction of the consensus mechanism. Thus, the disclosure is particularly suited for use in respect of database technologies and data storage/access, and also for providing security, control and authorisation solutions for such.

### TECHNICAL BACKGROUND—BLOCKCHAIN

Embodiments of the disclosure can be implemented in respect of any suitable blockchain and its associated network and protocol. A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### Terminology

While certain terms are common to various fields, they are understood by the relevant skilled person for those respective fields as having different meanings. Hereafter, we will use the following terms as having the meanings provided below, below unless specified otherwise:
database: hereafter means any “traditional”, non-blockchain based data collection, such as database technologies that may or may not be accessed via a DBMS as known in the technical fields of computing and information science, and including but not limited to document stores, relational databases, file storage systems, data warehouses, array DBMS, unstructured data DBs etc.
Transaction: this term can be used in the field of traditional databases and also in respect of financial operations. Herein, unless otherwise specified, the term “transaction” means a blockchain transaction i.e. a data structure formed in accordance with, and compatible with, a blockchain protocol;
Mapped: this term can be used interchangeably with “linked”, “indexed, “associated” “represented by” and/or “correlated with/to”;
Mapping: can be used interchangeably with linking, indexing, correlating with/to, referencing, representing and/or associating with.
Blockchain: We use the term ‘blockchain’ to include all forms of electronic, computer-based, distributed ledgers. These include, but are not limited to consensus-based blockchain and transaction-chain technologies, permissioned and un-permissioned ledgers, shared ledgers and variations thereof.
Bitcoin: we use the term “Bitcoin” to include the original Bitcoin protocol and implementation and also any and all protocols which derive from it or are variants thereof. While Bitcoin may be referred to herein for the purpose of convenience and illustration purely because it is the most widely known, it should be noted that the invention is not limited to use with the Bitcoin blockchain and associated protocol, and alternative blockchain implementations and their associated protocols/networks fall within the scope of the present invention. Herein, the term ‘Bitcoin’ may be used interchangeably with ‘blockchain’.
Consensus mechanism: a term known in the art of blockchain technologies; in accordance with a known definition, a consensus mechanism comprises a protocol that enables nodes of a distributed blockchain network to reach agreement regarding the state of the ledger, and sets the verification requirements that each blockchain transaction must meet in order to be accepted for inclusion on the ledger. As used herein, we use the term to include any type of blockchain related consensus mechanism including, but not limited to: Proof of Work (PoW), Proof of Stake (POS) or Delegated Proof of Stake (DPoS). The term “consensus algorithm” may be used interchangeably with “consensus mechanism”.

### BACKGROUND OF THE DISCLOSURE

Sometimes the blockchain is described as a database because, like databases, electronic ledgers can store data. However, there are significant differences between a blockchain and a database. Some examples of technical differences and relative advantages/disadvantages are provided below, without limitation:
a database has a centrally controlling administrator; by contrast, the blockchain is decentralized and there is no central, controlling authority. Instead, verification is performed implemented via a consensus mechanism that is written into the blockchain protocol and put into effect by nodes (minders) on the network
the controlling authority sets access permissions (at system and record levels) in a database, and so data can only be accessed from records if the centralized controller authorizes it; by contrast, outputs (e.g. UTXOs) in blockchain transactions (TXs) can only be spent if a requesting party provides the necessary information to comply with the locking script's conditions; therefore, in a blockchain context, access permissions are specified in line with the relevant protocol and implemented via cryptographic controls; Therefore, instead of being specified and enforced by a centralized controlling authority associated with a particular organization, the blockchain operates as a decentralized solution that is specified by a protocol that is adhered to but not specified by the network nodes;
in a database, the records are mutable unless write operations are specifically locked by the central controller; in a blockchain, however, all transactions are immutable as a result of the protocol design;
a separate transaction log is maintained for a database in order to provide a historical record of which operations were performed, when and by whom. The transaction log is critical for the regeneration of the traditional database in the event of e.g. a system failure so as to bring the database back into a consistent state; by contrast, each blockchain transaction (the database equivalent of a record) stores its own history of who did what to a particular piece of data via its inputs and outputs and time stamping mechanisms, and once written to the ledger this log becomes immutable.
databases can be corrupted and vulnerable to exploits, and so back-ups need to be taken at regular intervals. This requires storage and processing resources. By contrast, a blockchain is immutable so the data cannot be corrupted or altered after it has been confirmed on chain, and data integrity is cryptographically ensured and enforced
a database is easy and simple to implement and maintain as the technology is well known and widely used; blockchain-based technologies, on the other hand, can be more complex to implement, requiring more specialized expertise and time
in terms of scalability, databases can provide benefits over blockchains, depending on the protocol concerned
in databases, data-level operations such as create, search, write and read can be performed very quickly. Create and write operations to the blockchain, however, are slowed down by the protocol's integral verification and consensus mechanisms. Reading/searching a blockchain for a particular data item can be time and resource intensive due to the ledger's sequential nature and the need to iterative over individual blocks to identify the particular transaction that contains the target data.

Therefore, significant technical challenges would need to be overcome in order to find a solution which provides the benefits of two very different data storage technologies that comprise contrasting software and hardware architectures, whilst avoiding or at least alleviating their respective disadvantages.

### SUMMARY

The present disclosure comprises a solution in which a traditional database and/or database structure is mapped to a blockchain. This can provide an overlay which facilitates or enables storage, accessing, security and/or processing of data. Embodiments provide a solution in which permission controls for a traditional database are implemented and/or enforced by nodes on a blockchain network via their performance of tasks and functionality that is specified by the blockchain's protocol.

From one perspective, embodiments harness the strengths and benefits of both the blockchain and a traditional database, whilst eliminating or at least reducing their respective disadvantages for use as large-scale data storage mechanisms. From another perspective, the disclosure combines advantageous aspects of distinct, disparate technical platforms and architectures. In accordance with one possible embodiment, a traditional database is mapped to a blockchain such that the mapping enables, provides or functions as a blockchain-implemented overlay for a database.

The database can be implemented on or off chain i.e. on or off the blockchain. In other words, the individual data items can be stored within transactions in the blockchain, or can be stored off chain in any suitable storage mechanism. In one or more embodiments, this storage mechanism could be a traditional database. Examples include but are not limited to: a relational database, an SQL, New-SQL or no-SQL database, a graph database, or any hybrid or alternative to these named examples.

The database may comprise one, some or all of the components which are typically associated with a traditional database, including a DBMS, associated storage resources such as hardware and software for storage and retrieval of the data, APIs, languages for database manipulation and usage etc. (see, for example: en.wikipedia.org/wiki/Database).

In a preferred embodiment, an overlay is provided that maps at least one record in the database to at least one transaction (Tx) on a blockchain. In particular, it may map the record(s) to respective outputs (UTXOs) in the one or more transactions. From one perspective, a database record can, therefore, be represented as an unspent output of a blockchain transaction.

In a preferred embodiment, the output comprises a locking script. In some, but not all, embodiments, the locking script may also be known as scriptPubKey or PubKey Script, and may be a portion of code associated with a transaction output and specifies certain conditions that have to be met in order for another (further) transaction to spend the output. These conditions can include that the further transaction comprises an unlocking script (which may also be known as a scriptPubKey or Signature script in accordance with some embodiments) which provides proof of signature by one or more specified public keys.

Preferably, the further transaction is generated and submitted to the blockchain network when access is requested in respect of a particular record in the database. The consensus mechanism associated with the blockchain will, in accordance with conventional functionality, verify whether the required signatures and public keys have been presented to the locking script by the unlocking script. If they have, access to the database record is deemed authorized and the record can be accessed. If not, access is denied. In this way, the blockchain network, which implements the blockchain protocol, can be used as the sole verification and permissioning mechanism for the database. No pre-verification or post-verification of the user's authorization is required, other than verification by the nodes that form the consensus mechanism.

This provides a significant technical benefit in that performance of traditional database permission (e.g. privileges and user permissions) can be implemented and enforced by an existing blockchain consensus mechanism. This means that not only is the need for processing resources such as hardware, software and energy transferred from the database owner to the blockchain network, it also means that the permissions can be cryptographically enforced via the blockchain protocol, and an immutable record of who access what, and at what time etc can be provided on chain. Cf en.wikipedia.org/wiki/Database_security.

The overlay may be updated to reflect any events or processing operations that occur in respect of a given record. This may be an access event such as a read, write or copy operation. If a particular record is accessed in the database, the overlay entry for that record is updated to reflect the change.

In some embodiments, a transaction log may be provided which keeps a record of all events and changes pertaining to the state of the overlay. While this information can be extracted from the blockchain from the relevant transactions associated with the records, a separate transaction log may provide efficiencies in terms of time, energy and processing resources required to locate and compile the necessary information in the event that it is required. Thus, some embodiments may provide advantages in respect of database activity monitoring (DAM) (en.wikipedia.org/wiki/Database_activity_monitoring) and/or “back-up and restore” requirements in the event that the database needs to be reconstructed en.wikipedia.org/wiki/Backup.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain.

FIG. 2 schematically illustrates some examples of transactions which may be recorded in a blockchain.

FIG. 3A is a schematic block diagram of a client application.

FIG. 3B is a schematic mock-up of an example user interface that may be presented by the client application of FIG. 3A.

FIG. 4 is a schematic block diagram of some node software for processing transactions.

FIG. 5 is an overview of an embodiment in accordance with one or more embodiments of the disclosure.

FIG. 6 shows the embodiment of FIG. 5 in more detail.

FIG. 7 provides a flowchart illustrating steps which may be taken in accordance with one or more embodiments of the disclosure.

FIG. 8 provides an alternative view of the embodiment of FIG. 5, showing, in dotted lines, the relationships between the database records and their associated transactions.

### DETAILED DESCRIPTION OF ILLUSTRATIVE EMBODIMENTS

### The Database and the Data

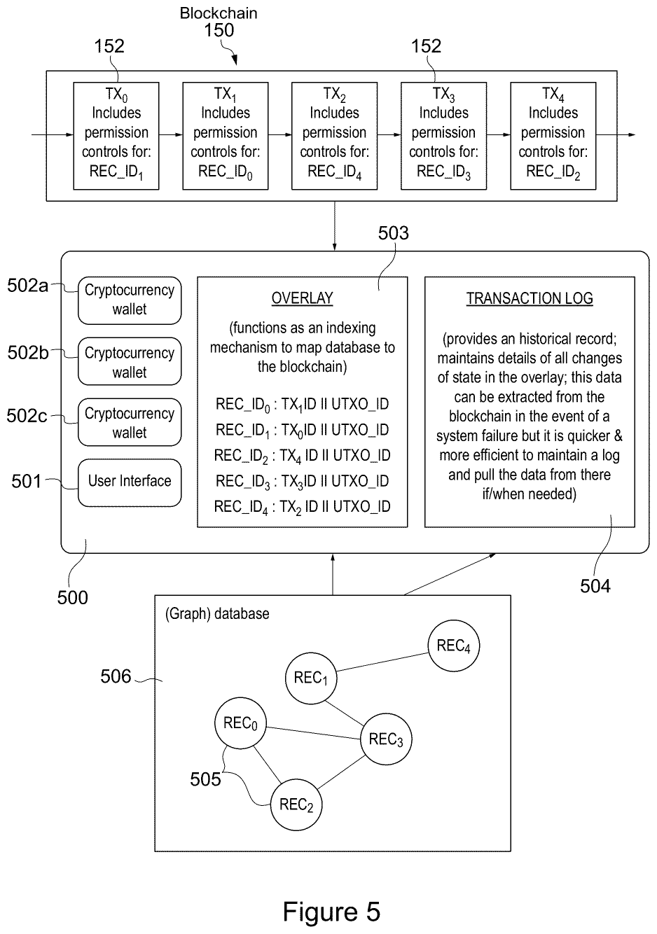

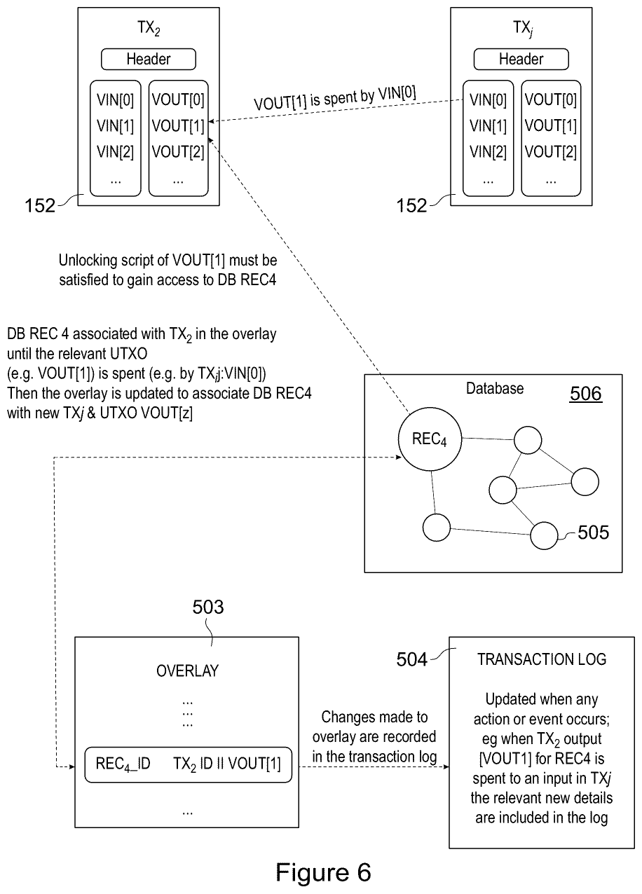

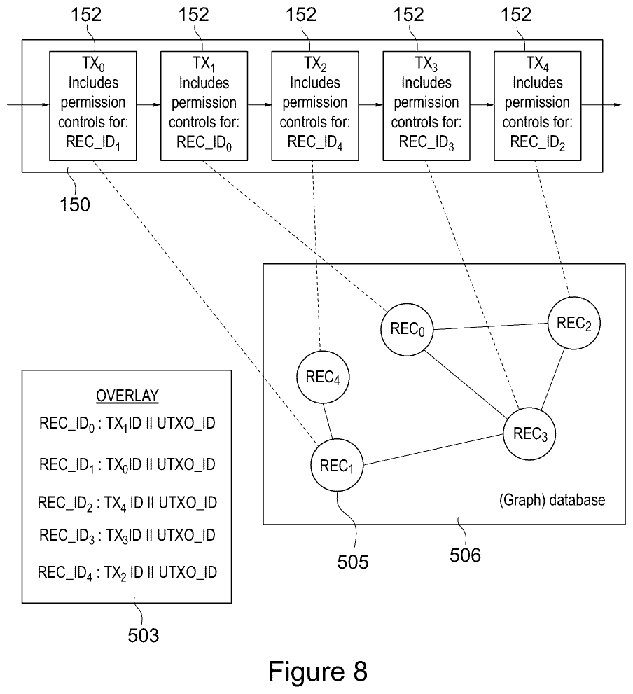

In one illustrative implementation, and with particular reference to FIGS. 5, 6 and 8, we map the contents of a database to a blockchain in such a way that the blockchain functions as an overlay mechanism. Amongst other benefits, this facilitates improved indexing and re-indexing of the database and its data items, provides improved security and authorisation techniques which are advantageously implemented via the traditional features and functionalities of the blockchain, and enables improved database back-up and restoration solutions.

The data stored in the database may take any form and can be arranged or suitable for any purpose(s). Although in our example the database is a graph-based database, the disclosure is not limited in this regard and could be arranged for use with any alternative form of database model or data store. However, it is well known that graph databases are especially suited for the storage and representation of many-to-many relationships between data items, such as those used by social media and other application areas which store, manipulate, generate, re-index and process large volumes of data items which are inter-related via complex relationships and connections. Therefore, embodiments are particularly suited for use with graph databases, thus giving rise to many potential, powerful applications.

We use the term “data item” to include one or more portions of data that are recorded in the database as an entity. This may be a, for example, a single data item such as a file, or may be a plurality of data items that are related in some way within the database and, therefore, may be viewed as an entity even if the data items are not stored in the same location or on the same device.

Although the term “node” is typically used in respect of data items that are stored in a graph database, we will use the term “record” to avoid confusion with “nodes” 104 in a computing network 106, and because embodiments may be used with other types of database models which comprise “records” akin to the nodes in a graph database. A record may comprise one or a plurality of data items, each of which may be stored in a distributed manner but associated logically as being part of the same record. Each record has a unique record identifier (record_ID) that enables it to be referenced and accessed as known in the art.

In accordance with some embodiments, the data items can be stored on chain (i.e. on the blockchain) or off chain, or a combination thereof. In our illustrative embodiment, the individual data items are all stored off-chain within records in a conventional (graph) database. However, other database and data storage implementations are equally suitable for use with embodiments disclosed herein. For example, one or more data items could be stored in transaction(s) on the blockchain using any suitable, known technique. For example, in a Bitcoin-related blockchain, data item(s) could be provided in a transaction by providing the data item(s) after an OP_RETURN statement in a script, or by including it as metadata, or by including a reference, pointer or other reference which enables identification of the data in or at an off-chain location. Multiple data items could be stored in separate outputs of the same transaction. In other cases, multiple transactions within the same block could comprise one or more data items, so that the data relating to a given record in the database is stored across separate locations. Alternatively, multiple transactions, each containing at least one data item, can be provided across a plurality of blocks on the blockchain. There is no restriction or constraint which requires the data-containing transactions to be in the same block.

### The Overlay Component

With reference to FIGS. 5, 6 and 8, the disclosure provides an overlay mechanism which maps one some or all records in the database with transactions on a blockchain. The overlay (“mapping”) associates one or more records in the database to at least one transaction (TX) on the blockchain. Any form of known transaction can be used. In our Bitcoin illustration, non-limiting examples could include pay-to-public-key-hash (P2PKH), Pay to Public Key (P2PK), pay to multi-signature (P2MS), pay-to-script-hash (P2SH).

The overlay comprises a list of entries, each entry pertaining to a record in the database that is to be mapped to the blockchain. In some implementations, the overlay is stored on chain in one or more transactions, but in others it is stored off chain. It can be stored digitally in any format or form. In our illustrative embodiment of FIGS. 5, 6 and 8, the overlay is stored off-chain.

In some examples, multiple records may be mapped to the same transaction while in others the records may be distributed across multiple transactions. In particular, each record listed in the overlay maps to a respective output in an on-chain transaction.

For each record entry in the overlay, there is (at least) an identifier that associates that record with a particular output 203 in a particular transaction 152i on the blockchain 150. For convenience, we will call this identifier the “on-chain index” or simply “index”. The output (UTXO) is unspent, and comprises a locking script which can only be spent by providing an unlocking script that meets the conditions specified in the locking script. As known in the prior art, the locking script specifies which cryptographic key(s) must be used in order to prove authorisation to receive the output's associated cryptocurrency. The would-be recipient provides this proof by including the required public key and signature via the unlocking script of a new transaction 152j. When the new transaction 152j is sent to the blockchain network it will be verified by the nodes. This verification checks the public key provided by the recipient against the key hash provided in the locking script, and also uses the public key to check the signature. If the script verification returns TRUE, then the cryptocurrency is unlocked and spent to the specified address.

Therefore, the conventional consensus mechanism of the blockchain protocol and network enforce a cryptographic authorisation process whenever an output is spent from one transaction to another via the ledger. Advantageously, embodiments of the disclosure harness this inherent authorisation feature to facilitate a cryptographically enforced authorisation for the database as explained below.

In addition to the record index, the entry/entries may comprise additional information relating to the data items/record. For example, at least one entry may comprise data relating or referring to other records/entries that the at least one entry has a relationship or association with. For example, a record index may comprise field(s) which identify other records/entries which are related to it. The field may comprise parameters which add additional information about the relationship—for example, parameters which indicate a hierarchical relationship with other records in the database, or a reference/address indicating where data item(s) related to the record can be accessed, or any other metadata that is relevant to the record.

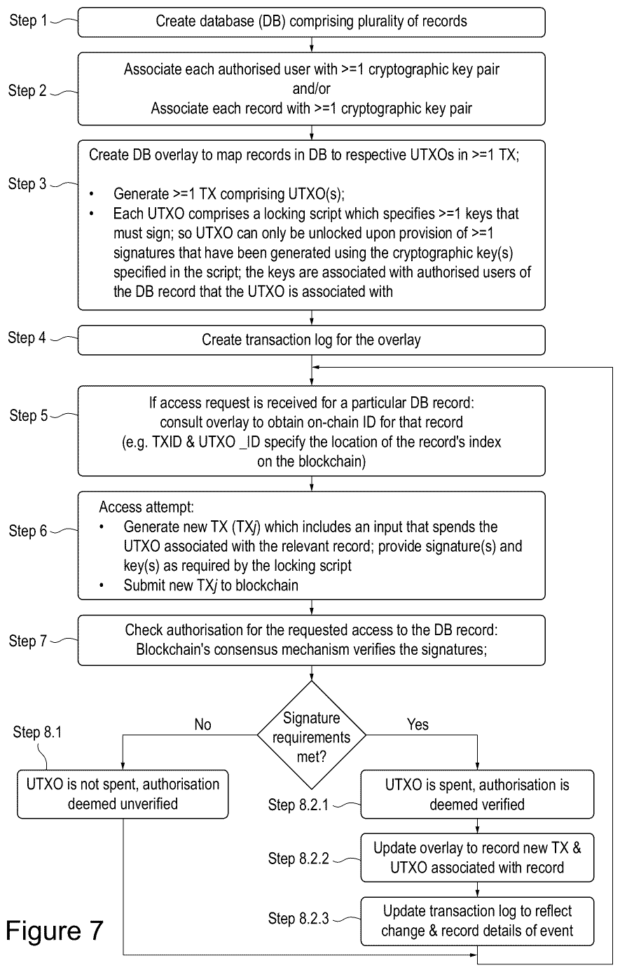

The record index specified in the overlay can take any suitable form. In our example, it comprises the transaction ID (TXID) of the transaction that the output is provided in, concatenated with an identifier for the output within the transaction. This is shown in FIGS. 5 and 7 as:

$$TXID ‖ UTXO\_ID$$

So where database record i maps to output y in transaction x on the blockchain, this could be written as

$$RECi ↦ TXxID ‖ UTXOy\_ID$$

As known in the art, each Bitcoin transaction that is successfully verified and written to the ledger has an ID (TXID) which is unique and never changes. Within each transaction, the outputs are listed in a vector (VOUT), such that each output in the transaction can be identified by its position/index in the VOUT vector starting with VOUT[0]. Therefore, in the above expression, UTXO_IDy could be replaced with VOUT[y] where y is the position of the relevant output in TXₓ's output list, giving:

$$RECi ↦ TXxID ‖ VOUT [ y ]$$

As explained above, in some examples, multiple records may be mapped to the same transaction, instead of or in addition to the overlay that can be maintained off-chain. In such an embodiment, all records in the database may be initially mapped to respective outputs in a single blockchain transaction, so that a single transaction effectively becomes an online schema or index listing for the entire database. This initial transaction 152i may be called the root transaction or the Genesis transaction for the overlay. Individual outputs of the genesis transaction may be subsequently spent each time that their associated records are accessed, leaving an immutable, auditable trail of timestamped events and details of the users who performed them for each record. Each of these output trails can be traced back to the original root/genesis transaction for the database.

### Transaction Log

In some embodiments, a transaction log may be maintained to facilitate restoration and recovery of the database in the event of a hardware/software failure, or corruption of the contents etc. The transaction log provides an historical record of all events that have occurred relating to the database, and maintains details of all changes of state in the overlay. Although this data can be extracted from the blockchain in the event of a system failure, it may be more efficient to maintain a log and restore the database from the log. The transaction log may comprise one or more components of the overlay system disclosed herein.

### Accessing a Record

When a user wishes to access a record in the database, an access request is passed to the Overlay component of the system. The overlay component identifies the relevant entry for the record and obtains, from the entry, all necessary data to enable the generation of a transaction that spends the output of the associated transaction 152i. This data can include one or more of: the transaction identifier (TXID), the output identifier (VOUT[y]), an address that the cryptocurrency associated with the output should be spent to, the public key(s) associated with the record. The address may be a cryptocurrency address that is generated by and/or stored in a wallet. The wallet may be a component of the overlay system.

Once the necessary data has been obtained, the new transaction 152j is generated and broadcast to the network 106 of nodes 104. The nodes 104 validate the transaction and, if successful, the transaction is mined into a block 151 and added to the ledger 150. This causes the output 203 of the previous transaction to be spent to the new transaction. The entry details for the record are updated to reflect that the record is now associated with a particular unspent output in the new transaction. The transaction log may also be updated with the event details. A new cryptographic (sub) key may be generated to replace the key that was used to spend the output during the access request, and that new key may be associated with the record and/or user in the overlay. The cryptocurrency associated with spent output is spent to the specified address. The new transaction will include an output that has a locking script, specifying the key(s) that must be used to unlock it, and the address that the cryptocurrency will be spent to. Unless an administrator has changed the authorisation details in the overlay entry for the record (e.g. because an employee has left the organisation, so their authorisation data/key(s) are deleted from the entry) the new transaction will require keys provided by the same authorised party/parties (i.e. user(s)).

During validation by the nodes, the protocol requires that locking and unlocking scripts are evaluated. This involves checking that the required public key(s) and signature(s) have been provided in the unlocking script. Therefore, the consensus mechanism that is built into the blockchain protocol performs the permissioning function that would traditionally be performed as part of the database application.

### In-Use Example

With reference to the Figures, (and in particular, FIG. 7), we now provide an example of how an illustrative embodiment could be used. Steps may be performed in practice in a different order from those shown in FIG. 7, and some may be omitted and/or other steps which are not shown may be inserted.

In Step 1, the database 506 is generated. As explained above, the database can take any known form that is suitable for the needs of the use case.

In Step 2, using a user interface 501 that is a component of the control system 500 disclosed herein, an administrator or user associates each authorised user with one or more cryptographic key pairs, each consisting of a public key and a corresponding private key. The user/administrator may generate the key(s) using a digital wallet or other key generation component known in the art, wherein the wallet 502a, 502b, 502c is associated with the user/administrator, hereafter simply “user”. Each user may have their own digital wallet 502a, 502b, 502c for generation and storage of keys that can be used to verify their authorisation for accessing records, and for generation of cryptocurrency addresses. The wallet 502a, 502b, 502c may comprise some cryptocurrency to enable spending of outputs during access events. The user may maintain and/or use the control system 500 via interaction with the user interface 501. The user interface 501 may facilitate operations such as creation of a new record entry, creation of a new authorised user for one or more records, deletion of one or more records or authorised users etc.

A record of which keys are associated with each user may be stored and maintained e.g. by the administrator. Each key pair provides a permission mechanism that the user can use to unlock a particular record. The database 506 may be arranged such that at least some of the records 505 form a hierarchical structure. In such cases, sub-keys may be generated for records in different levels within the hierarchy. A technique such as that disclosed in WO2017/145016 (PCT application PCT/IB2017/0500856) can be used to deterministically generate sub-keys from a master key, thus enabling the generation of a hierarchy of cryptographic keys which reflects the hierarchical structure of the records.

In step 3, the database overlay 503 is generated to map the records 505 in the database 506 to respective outputs 203 in one or more transactions in the blockchain ledger 150. This step may comprise the action of generating one or more blockchain transactions 152 which comprise the outputs 203 representing and associated with the respective records 505 in the database 506. The transaction(s) are submitted to the blockchain 150. Therefore, for each record 505 in the database, there is a Genesis transaction that subsequent transfers (output spends/access events) can be traced back to for a given database record 505. That trace will provide an auditable, timestamped and irrefutable record of who did what with each record 505.

Each user and their associated public key(s) and corresponding record_ID may be recorded within the overlay component 503 so that the overlay can be interrogated or queried to determine which user(s) have permission to access a particular record 505, or which record(s) a particular user has permission to access. A user may perform such queries to generate reports, and may use the interface 501 to interact with the permission control system 500.

At least one blockchain transaction 152 is generated comprising the UTXOs 203 which represent the respective records 505. Each UTXO 203 comprises a locking script which specifies at least one key that can be used to unlock the output and spend its associated cryptocurrency. Therefore, the UTXO 203 can only be unlocked upon provision of at least one key and corresponding signature. In some cases, the script may allow one or more of a group of authorised keys to be used to unlock the output, as known in the art of blockchain transactions (ie. an “n-of-m” or “multisig” transaction). The script may comprise an “OR” or selection function so that any authorised party in a set of authorised parties can access the record(s).

In practice, the keys may be generated as sub-keys of a master key. For example, the initial key associated with a given user and/or record may be used as a master key for the generation of sub keys that are associated with sub-records derived from the record. This is advantageous when the database comprises hierarchies of records and the associated key structure needs to reflect the record structure. The sub keys may be generated using a technique substantially as disclosed in WO2017/145016 (which is incorporated herein in its entirety) or any other suitable sub-key generation technique. In some embodiments, a new and/or sub key may be used for each new output that a given record is associated with. This can enhance security by making it more difficult to discern the recipient that the output is spent to.

In step 4, the transaction log 504 is generated (optional). This will be updated each time an output is spent. Any new key(s) associated with the respective records 505 will be recorded.

In step 5, suppose that a user wishes to access a particular record in the database 506. When such a need arises, an access request may be generated by the user and sent to the overlay. The overlay component 503 may be queried to obtain the on-chain ID for that record 505. In other words, the ID for the output that is associated with the target record. In our example, this identifier is the transaction ID (TXID) combined with the UTXO identifier which, together, specify the location of the record's index (output) on the blockchain. An authorisation check will need to be performed to ensure that the source of the access request has permission to access the target record, and is legitimately allowed to do so.

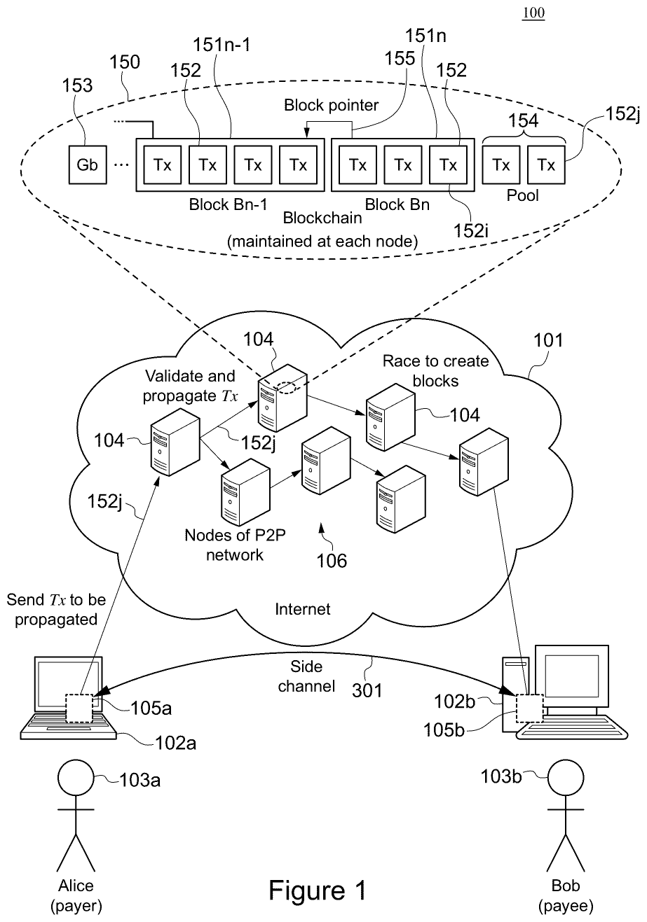

In step 6, responsive to the access request, a new (further) blockchain transaction (Tx) is generated and is arranged to spend the UTXO presently associated with the record. This may be generated by the user's (or a manager's) wallet. The Tx comprises an input 202 that has an unlocking script which provides the public key and a signature generated by that public key in order to satisfy the requirements specified by the locking script 203 of the UTXO in the TX that is currently associated with the target database record. In some cases, more than one public key and corresponding signature will be provided in the unlocking script, depending on the conditions set in the locking script. The unlocking script provides an address that the cryptocurrency will be spent to. The further transaction is submitted to the blockchain network 106 for verification by mining nodes 104 and, if successful, addition to the ledger 150. (note, the FIGS. 5, 6 and 8 show only transactions not the blocks that they are provided in on the ledger 150. The blocks are, however, shown in FIG. 1).

In step 7, the nodes verify the new transaction in accordance with the consensus rules specified in the blockchain protocol. This involves checking, by the nodes 104, that the correct keys and minimum number of keys have been provided by the unlocking script and that those keys have been used to generate the provided signatures.

At Step 8.2.1, if verification is successful, the user's access request is deemed authorised. The record's output is spent and the cryptocurrency is transferred to the recipient's address in accordance with protocol rules. The record now becomes associated with a new UTXO in the further transaction, TXⱼ. The database record is locked on a first come first served basis until the present access is terminated. The overlay entry for the record is updated to associate the record with a new UTXO in the further transaction. If required, a new (sub) key is generated for the new UTXO and is associated with the record in the overlay. If a transaction log has been implemented, the transaction log is updated to reflect the event.

At Step 8.2.2, if the consensus mechanism fails to verify the attempted spend of the UTXO, access to the record 505 is denied.

An advantage of the disclosure is that it enables mapping of the database 506 to the blockchain 150 so that it is possible to perform searching and other operations using a Simplified Payment Verification (SPV) style approach. SPV is known in the art, having been introduced in Section 8 of Satoshi Nakamoto's white paper: “Bitcoin: A Peer-to-Peer Electronic cash System”, (2008), and utilises the blockchain protocol's inherent design, which incorporates Merkle-proofs, to provide an efficient way of verifying the presence of a target transaction (and thus its inputs) on a blockchain without needing access to the whole blockchain. Instead of looking up individual transactions on chain as per conventional approaches, in accordance with the disclosure the records are directly indexed in a manner similar to a hash database. Therefore, the edges between the nodes (records) in the overlay correspond to paths in a Merkle tree. An advantage of this is that the paths are stored dynamically in the blockchain over time.

As a result, re-indexing of the data can be performed more rapidly, requiring less processing and fewer resources because there is no need to repeatedly perform a sequential search across the whole blockchain each time a particular record/data item of interest needs to be accessed. By contrast, using embodiments of the disclosure a user can inspect a given TX, look at the mappings that relate to it, and see that TXa maps to TXb maps to TXc maps to TXd and so on. The transactions are all linked via the mapping even though they may be in different blocks on chain. This provides a much faster and more efficient solution for searching than having to iterate over the ledger block by block until the target transaction is found.

Also, the above embodiments harness the existing consensus mechanism for the blockchain in order to implement the permissioning and authorisation components of the system. Access requests are, effectively, granted or denied based on the outcome of the consensus mechanism's work. In a preferred embodiment, no verification effort is required by the overlay/DBMS because this is handled by the blockchain network instead.

This is in contrast to prior art arrangements such as PCT/IB2020/057762 (published as WO2021/033134) which uses a DBMS to verify the requesting user's access permissions and, if the user is deemed authorised, write a record of the event in an unspendable output of a transaction on the ledger. The contents of the applicant's co-pending application number PCT/IB2020/057762 (published as WO2021/033134) is incorporated herein in its entirety. The contents of WO2017/145016 (PCT application PCT/IB2017/0500856) are also incorporated herein in their entirety.

### Example of Blockchain System Overview

FIG. 1 shows an example system 100 for implementing an illustrative blockchain 150 that may be used in respect of embodiments of the disclosure. This example is not limiting or exclusive and is provided as one possible implementation out of many possibilities. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

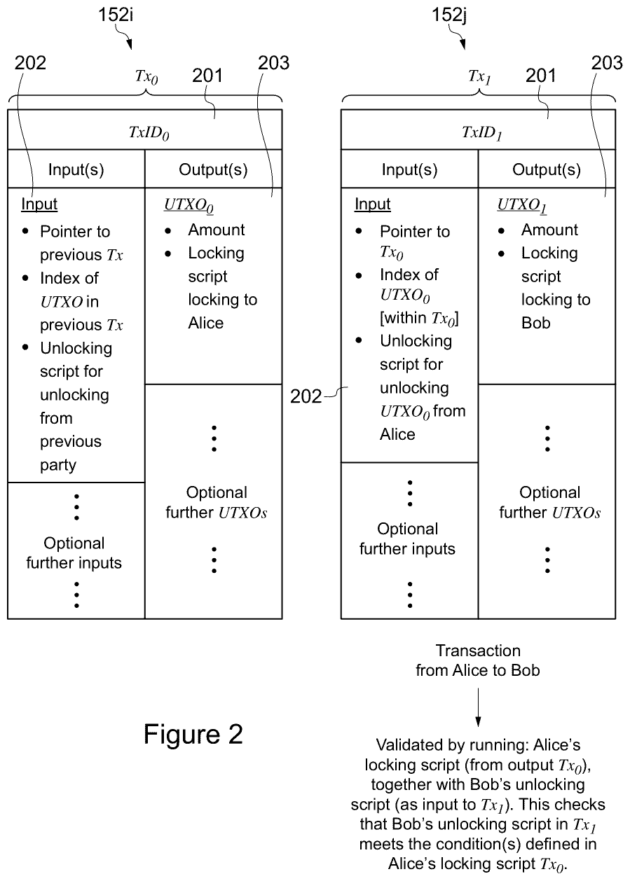

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > ‖ [ Checksig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

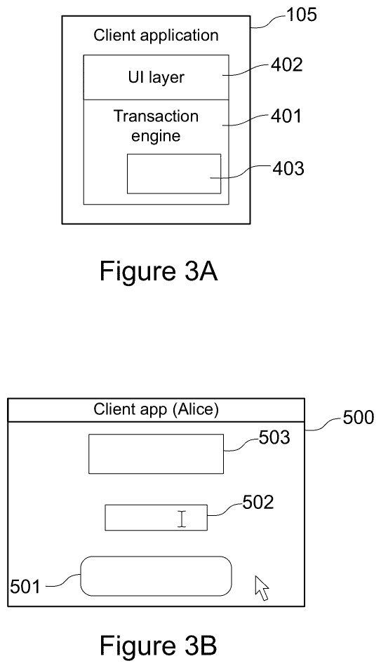

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 . . . .

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to . . . .

Alternatively or additionally, the UI elements may comprise one or more data entry fields 502, through which the user can . . . . These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

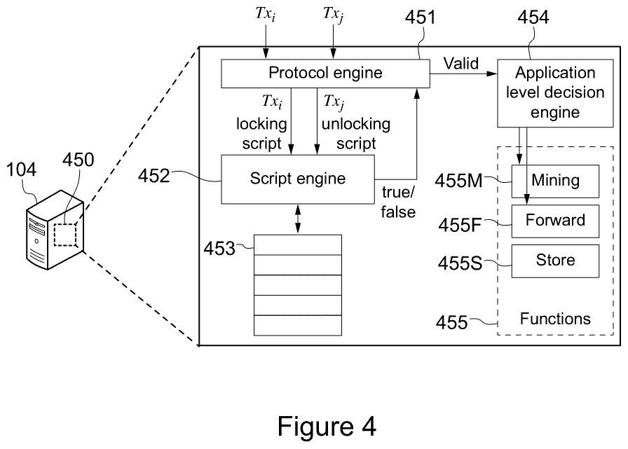

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

### ENUMERATED STATEMENTS

The disclosure may be described as providing a computer implemented method, and/or a computer program embodied on computer-readable storage and configured so as, when run on one or more processors, to perform the method of any of embodiment claimed or disclosed herein. One or more of the method steps disclosed herein may be performed by a computer-based resource comprising at least one processor. Embodiments of the disclosure may comprise methods and computer-based systems that are operative to implement said methods.

The term “mapping” may be used interchangeably with the terms “overlay” or “indexing resource”. The system disclosed herein may be referred to as a “database control system” and/or a “database permission system”, “database overlay system” and/or a “database security system”, and/or “database indexing system” and/or “database querying system”.

The corresponding methods may be referred to as “database security/control/permissioning/overlay/indexing/querying method”.

In accordance with some forms of wording, embodiments disclosed herein may be described as comprising a method for/of performing or facilitating any one or more of the following:
using a [public or private] blockchain to provide an overlay facility or resource over a database;
preferably wherein the overlay facility or resource implements, facilitates or enables indexing of one or more records of the database; and/or
verification or implementation of at least one permission control (which may be referred to as “at least one authorisation condition”) for the database; and/or
enabling or using a blockchain consensus mechanism to serve as a permissioning mechanism for a database, preferably wherein the consensus mechanism is the sole permissioning mechanism for permitting/denying access to record(s) in the database; and/or
using a plurality of (mining) nodes on a blockchain network to implement, perform and/or enforce at least one permission control for a traditional database via the performance, by the plurality of nodes, of task(s) and functionality specified as part of the blockchain's protocol; “permission control” may be used interchangeably with “access control” and/or “user privilege” and/or “user verification”;
providing an overlay/indexing/mapping facility and/or resource for associating record(s) of or in a database records with transaction(s) of or in a blockchain; and/or
providing a resource which is a hybrid or conglomeration of a [traditional] database and a blockchain; and/or
a search or indexing process for a database; preferably wherein the search or indexing process comprises:
   the use of a Merkle tree or Merkle path to validate that a given transaction is traceable to >=1 Genesis transaction associated with one or more database records; preferably wherein respective outputs in the transaction(s) are associated with records in the database; preferably wherein the association between the records and the outputs is stored in an overlay component of a system.

In one, some or all embodiments, access to one or more records in the database may be granted or prohibited based upon successful or unsuccessful verification of a spending transaction, by a consensus mechanism for the blockchain. The record(s) may be associated with at least one output of a blockchain transaction that is spent by an input of the spending transaction.

Additionally, or alternatively, it may be described as providing a method for:
using or maintaining a mapping to associate at least one record in/of a database with at least one (respective) (unspent) transaction output on a blockchain. Preferably wherein:
   the overlay is provided/stored separately from the database; and/or
   the overlay is stored off the blockchain, but in other embodiments may be stored on-chain; and/or
   access to the at least one record is controlled by or via a consensus mechanism associated with the blockchain; preferably wherein access to the at least one record is allowed/denied based upon successful/unsuccessful spending of the transaction output after processing of a (further/spending) blockchain transaction by a consensus mechanism of the blockchain;
   the processing may comprise verification of the further transaction by nodes operating or implementing the consensus mechanism; and/or
   the mapping (or “association”) between the at least one record and the at least one output provides or facilitates a blockchain-based or blockchain-implemented overlay for the database.

In an additional or alternative form of wording, the disclosure may provide a method comprising the steps:
using a (public) cryptographic key, and/or digital signature generated using the cryptographic key, to spend an output in a first transaction on the blockchain, wherein the key and/or signature are provided in the unlocking script of a further transaction on the blockchain;
granting access to at least one database record upon spending of the output;
preferably wherein:
the at least one database record is associated with the output and/or first transaction in a stored mapping.
The method may further comprise the step of updating the mapping to associate the at least one database record with the further transaction and/or an output in the further transaction.

In an additional or alternative form of wording, the disclosure may provide a computer implemented method comprising:
associating at least one record in a database with an unspent output of a first blockchain transaction, wherein the unspent output comprises at least one authorisation condition for verifying whether at least one party is authorized to access the at least one database record.

The database may be an off-chain (traditional) database, or may be implemented in association with a blockchain ledger.

The method may further comprise one or more of:
i) granting access to the record upon successful validation, by a consensus mechanism of a blockchain network, of a further blockchain transaction comprising an input arranged to satisfy the authorization conditions of the unspent output; and/or
ii) interpreting successful validation of a further blockchain transaction by a consensus mechanism of a blockchain network as successful validation of the at least one authorized party and permitting access to the at least one record by the authorized user, wherein:
   the further transaction comprises an input and/or unlocking script arranged to spend the output of the first transaction; and/or
successful validation of the further blockchain transaction by the consensus mechanism causes: the unspent output to be spent and/or the further transaction to be written to the blockchain.

In feature i), granting access to the record may be based or dependent upon successful validation, by the consensus mechanism of the blockchain network, of the further blockchain transaction. In other words, the blockchain consensus mechanism may provide the (preferably sole) verification/permissioning mechanism for the database. If the network nodes that form the consensus mechanism verify the transaction, the user's access request will be granted otherwise it will be denied.

The authorized party may be an administrator, end user or any other user of the database 506 and/or overlay system 500. The authorized party may be a human user or a computing resource. The method may further comprise the step of storing the association (record entry) in a storage resource 503.

In an additional or alternative form of wording, the overlay provides a mechanism for indexing one or more database records (in a database), each record being associated in the overlay with a respective index. The indices may be blockchain-based or implemented on the blockchain. Preferably, the respective indices are associated with, or representations of, or indicative of unspent outputs in one or more blockchain transactions. One or more index may comprise an identifier, the identifier may comprise an identifier for an unspent output (UTXO) and/or a blockchain transaction. The unspent output may be provided as an element in a collection 154 of unspent transaction outputs (e.g. the Bitcoin mempool) that is associated with a blockchain.

In an additional or alternative definition, the disclosure may be described as providing a method comprising one or more of the following steps:
associating a record in a database with an output of a blockchain transaction, wherein the output comprises a locking script that specifies at least one cryptographic key that must be provided/used in order to spend the output;
receiving a request to access the at least one record and, responsive to the request, generating a further blockchain transaction comprising an unlocking script that provides/uses the at least one cryptographic key;
submitting the further transaction to a one or a plurality of computer-based resources for verification in accordance with a protocol associated with the blockchain,
deeming the request to be authorized if verification of the further transaction by the one or plurality of computer-based resources is successful; or, if it is unsuccessful, deeming the request to be unauthorized.

Preferably wherein the verification is performed by one or a plurality of computer-based resources; the computer-based resources may be (mining) nodes on or in a blockchain network, the nodes being arranged to implement the protocol and/or consensus mechanism associated with the blockchain that the transaction is generated in accordance with.

The overlay may comprise part of an overall system arranged and operative to interact with the blockchain, the blockchain network, the database and/or a DBMS.

In an additional or alternative definition, the disclosure may be described as providing a method comprising one or more of the following steps:
providing, generating or using a mapping which comprises one or more entries related to, indicative of, or representative of a record in a database;
wherein the one or more entries comprises an association between the record and an output of a blockchain transaction.

Preferably wherein:
i) the mapping functions as or provides a blockchain-related overlay over the database;
ii) the mapping and/or one or more entries comprise machine-readable code for associating the record with an output of a blockchain transaction, preferably wherein a) the transaction has been written to a blockchain and/or b) the output is unspent.

Any embodiment described herein may comprise one, some or all of the following steps:
generating at least one blockchain transaction which comprises a plurality of outputs, each output representing or associated with at least one record, or at least one group of records, or all records in a database. This at least one transaction may be referred to as the “genesis transaction” or the “root transaction” for the overlay disclosed herein;
spending an output associated with a record (or group of records); spending of the output may be interpreted by a system that implements the overlay as meaning that an event e.g. an access operation or other processing event, has occurred in respect of the record(s) associated with the output, and/or has been authorized by a consensus mechanism of the blockchain.
searching for a target (unspent) output in transaction on a blockchain ledger, the target output being associated with a record or group of records in a database;
the search may comprise the use of a Merkle path or proof to locate the transaction;
the search may comprise the use of a Merkle proof or path which has the root transaction disclosed herein at the root of the Merkle path; for example, the search may comprise a SPV (style or similar) search which does not require downloading of the entire blockchain.

The disclosure may also provide a computer-implemented system arrange and operative to perform the method of any embodiment disclosed herein. The system may comprise an overlay component operative to interact with:
a blockchain formed in accordance with a protocol; and/or
a network of nodes arranged to implement a consensus mechanism specified and/or
required by the protocol; and/or
a database; and/or
a digital wallet; and/or
a DBMS associated with the database.

The system may comprise one or more of: at least one digital (cryptocurrency) wallet; an overlay component substantially as disclosed herein; a transaction log substantially as disclosed herein; a data storage component for storage of entries relating to database records; hardware and/or software arranged to facilitate performance of any function or method step disclosed herein.

The overlay component may be operative to perform one, some or all of the following:
generate a blockchain transaction formed in accordance or compliance with the protocol;
communication with the database and/or DBMS;
submit the transaction to the network for validation and/or mining;
search for a target transaction on the blockchain and/or an output provided in the target transaction.

Any or all of the clauses listed below may be used in conjunction with the wordings and definitions given above. The following clauses should not be construed as being limiting or exclusive with respect to the scope of protection that may be claimed for an embodiment of this disclosure.

### Enumerated Clause Set 1

Clause 1. A computer implemented method comprising:
   associating at least one database record with a blockchain transaction (Tx), wherein the blockchain transaction comprises a permission mechanism for specifying and/or verifying at least one authorized party (AP) that is authorized to process the at least one database record. Process may comprise ‘receive’, ‘store’, ‘read’, ‘modify’ and/or ‘delete’.
   “Access” can include read, copy, delete or write operations, or any other operation or processing that may be performed on the at least one record.
   “Permission mechanism” may be used alternatively with “least one authorisation condition”. The term “attribute” may be used instead of “mechanism”.
Clause 2. A method according to Clause 1, wherein:
   the permission mechanism comprises a script and/or at least one cryptographic key associated with or controlled by the at least one authorized party.
Clause 3. A method according to Clause 1 or 2, wherein:
   i) the permission mechanism is operative to use a consensus mechanism associated with [a protocol of] the blockchain to verify an access operation request; and/or
   ii) the script comprises or implements a control operation which enables or facilitates selective access of the at least one database record by one or more of the at least one authorized parties;
      preferably wherein the control operation may comprise a selection operation such as an IF or CASE, and/or a Boolean operator such as an OR, AND, XOR or NOT.
Clause 4. A method according to any preceding Clause, and comprising the step of:
   repeating the associating step to provide a plurality of associations, each associating at least one database record with a blockchain transaction.
Clause 5. A method according to any preceding Clause, wherein:
   i) the mapping is stored on the blockchain or in an off-chain resource; and/or
   ii) the mapping comprises an identifier for the database record (REC ID) and/or an identifier for the blockchain transaction (TxID) and/or an output of the blockchain transaction;
Clause 6. A method according to any preceding Clause, and comprising the step of:
   providing an event record which implements, enables or facilitates the functionality of a database transaction log; preferably wherein:
   i) the event record comprises a list of all or some blockchain transactions historically associated with the records in the database; and/or
   ii) the event record is stored on or off the blockchain.

The individual blockchain transactions may provide historical information i.e. a transaction log of the database records; therefore, a master index of all the blockchain transactions that represent records in the database provides a full transaction log of the entire database.
Clause 7. A method according to any preceding Clause, wherein:
   i) processing the at least one database record comprises at least one of: accessing, reading from, deleting, modifying or writing to the database record; and/or
   ii) each database record relates to, stores and/or represents at least one portion of data and which:
      is stored on or off the blockchain; or
      is pointed to or referred to from the blockchain transaction; and/or
   iii) the database is a graph database, a relational database or an SQL database.
Clause 8 A method according to any preceding Clause, wherein the blockchain transaction comprises one or more of:
   i) data relating to or associated with the database record;
   ii) a pointer to, a reference to or an identifier for the database record or its storage location;
   iii) data relating to one or more further database records that are associated with the database record.
Clause 9. A method according to any preceding Clause, wherein:
   the at least one authorisation condition is arranged to facilitate a request or attempt to unlock/satisfy/redeem a locking script which is associated with the unspent output (UTXO) of the blockchain transaction, wherein:
   i) the UTXO is associated with the record and/or party in an index or overlay;
   ii) the UTXO can only be unlocked/satisfied/redeemed upon successful verification of the transaction by the consensus mechanism of a blockchain network;
   iii) unlocking/satisfying/redeeming the locking script comprises provision of at least one required cryptographic key;
   iv) unlocking/satisfying/redeeming the locking script results in an update or change being made in a master index;
   v) unlocking/satisfying/redeeming the locking script results in the UTXO being spent to an address specified in an input of a further blockchain transaction
   vi) updating the mapping to associate the further blockchain transaction with the database record.

Any incorporation by reference of documents above is limited such that no subject matter is incorporated that is contrary to the explicit disclosure provided herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein. In the event of inconsistent usages between this document and those documents so incorporated by reference, the usage in the incorporated reference(s) should be considered supplementary to that of this document; for irreconcilable inconsistencies, the usage in this document controls.

1. A computer implemented method comprising:
associating a record in a database with an unspent output of a first blockchain transaction, wherein the unspent output comprises at least one authorisation condition for verifying whether at least one party is authorized to access the database record;
granting access to the record upon successful validation, by a consensus mechanism of a blockchain network, of a further blockchain transaction comprising an input arranged to satisfy the at least one authorisation condition of the unspent output.

2. The method of claim 1, wherein:
the at least one authorisation condition comprises at least a portion of a script and/or at least one cryptographic key associated with or controlled by the at least one party.

3. The method of claim 1, wherein
the at least one authorisation condition is operative to use the consensus mechanism associated with a protocol of the blockchain to verify a request to process the record.

4. The method of claim 1, and comprising the step of:
repeating the associating step to provide a plurality of associations, each associating at least one record with an unspent output of the same or another blockchain transaction.

5. The method of claim 1, wherein associating the record with the unspent output provides a mapping that:
is stored on the blockchain and/or in an off-chain resource; and/or
comprises an identifier for the record and/or an identifier for the blockchain transaction and/or an unspent output of the blockchain transaction.

6. The method of claim 1, and comprising the step of:
providing an event history which implements, enables or facilitates a functionality of a database transaction log.

7. The method of claim 1, wherein
accessing the record comprises at least one of: processing, reading from, deleting, modifying or writing to the record.

8. The method of claim 1, wherein the blockchain transaction comprises one or more of:
data relating to or associated with the record;
a pointer to, a reference to or an identifier for the record or its storage location;
data relating to one or more further records that are associated with the record.

9. The method of claim 1, wherein:
the at least one authorisation condition is arranged to facilitate a request or attempt to unlock/satisfy/redeem a locking script which is associated with an unspent output (UTXO) of the blockchain transaction, wherein:
the UTXO is associated with the record;
the UTXO can only be unlocked/satisfied/redeemed upon successful verification of the transaction by the consensus mechanism of a blockchain network;
unlocking/satisfying/redeeming the locking script comprises provision of at least one required cryptographic key;
unlocking/satisfying/redeeming the locking script results in an update or change being made in an index or overlay;
unlocking/satisfying/redeeming the locking script results in the unspent output being spent to an address specified in an input of the further blockchain transaction.

10. A computer-implemented method comprising the steps of:
generating at least one blockchain transaction which comprises a at least one output that represents or is associated with at least one record, at least one group of records, or all records in a database;
searching for a target output in a target transaction on a blockchain ledger, the target output being associated with a record or group of records in a database and having the at least one blockchain transaction in its on-chain history;
wherein the search comprises a use of a Merkle path or proof to locate the target transaction.

11-13. (canceled)

14. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of:
associating a record in a database with an unspent output of a first blockchain transaction, wherein the unspent output comprises at least one authorisation condition for verifying whether at least one party is authorized to access the database record; and
granting access to the record upon successful validation, by a consensus mechanism of a blockchain network, of a further blockchain transaction comprising an input arranged to satisfy the at least one authorisation condition of the unspent output.

15. (canceled)

16. The method of claim 1, wherein the at least one authorisation condition is arranged to specify and/or verify the at least one party.

17. The method of claim 2, wherein the at least one authorisation condition is a required feature of the script as specified by a protocol associated with the blockchain and/or implemented by a network of nodes operating in accordance with a protocol associated with the blockchain.

18. The method of claim 1, wherein the unspent output comprises a script which comprises or implements a control operation that enables or facilitates selective access of the at least one record by one or more of the at least one parties.

19. The method of claim 18, wherein the control operation may comprise a selection operation such as an IF or CASE, and/or a Boolean operator such as an OR, AND, XOR or NOT.

20. The method of claim 6, wherein the event history comprises a list of all or some blockchain transactions historically associated with one or more records in the database.

21. The method of claim 6, wherein the event history is stored on or off the blockchain.

22. The method of claim 1, wherein the record relates to, stores and/or represents at least one portion of data and which:
is stored on or off the blockchain; or
is pointed to or referred to from the blockchain transaction.

23. The method of claim 1, wherein the database is a graph database, a relational database or an SQL database; and/or comprises a Database Management System (DBMS).
